(19) United States
(12) Patent Application Publication
(10) Pub. No.: US 2010/0263804 A1
(43) Pub. Date: Oct. 21, 2010

(54) Window blinds that let in air but block out light

(76) Inventor: Tel Shprung, Tel Aviv (IL)

Correspondence Address: TAL SHPRUNG, P.O. BOX 29746, TEL AVIV, 61297, IL

(21) Appl. No.: 12/802,755

(22) Filed: Jun. 15, 2010

Related U.S. Application Data
(63) Continuation of application No. PCT/IL2008/001597, filed on Dec. 19, 2007.

(30) Foreign Application Priority Data
Dec. 19, 2007 (IL) 188255

(51) Int. Cl. E06B 9/08; E06B 9/26

(52) U.S. Cl. 160/133; 160/174 R; 160/176.1 R

(57) ABSTRACT

A window shade that consists of several louvers positioned one above the other. Each of the louvers is, in fact, composed of two identical halves that are connected to one another by means of a cylindrical rod that serves as an axis and a connector between the two halves of the louver. A window shade that is composed of louvers, each of which consists of two parts positioned at varying angles to each other, such that the angle between the two parts of the louver can be changed and the shade can be fully closed, fully opened or in a position that lets air, but not light, into the room.

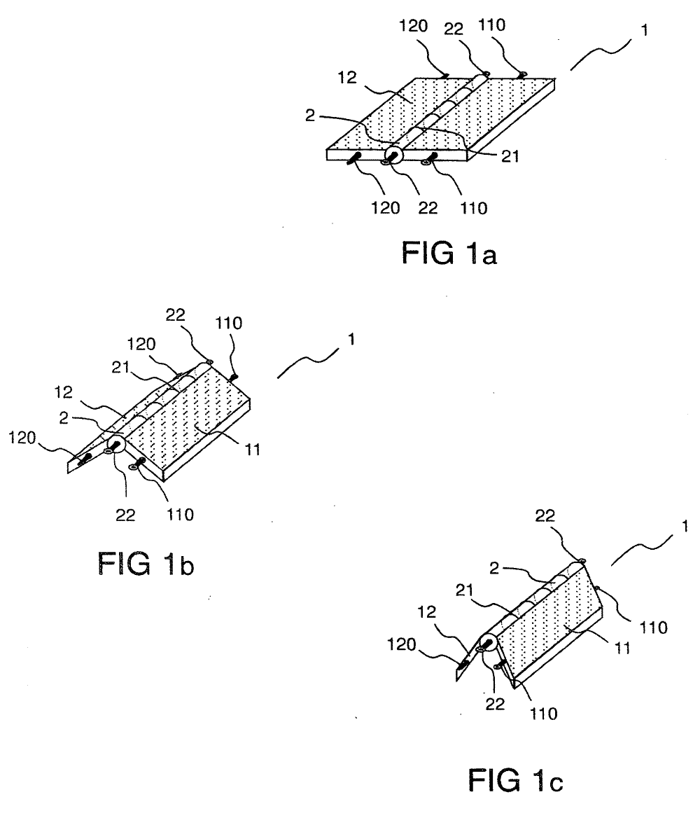

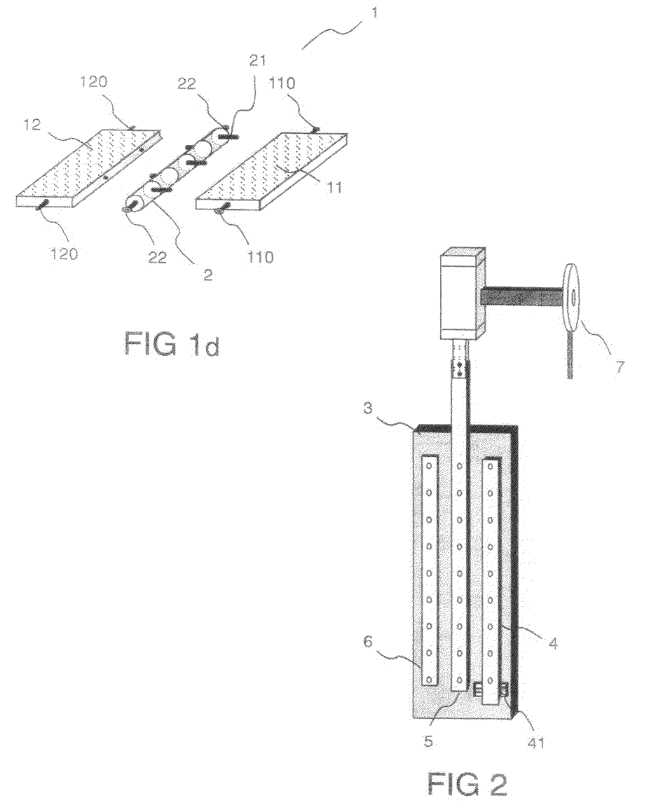

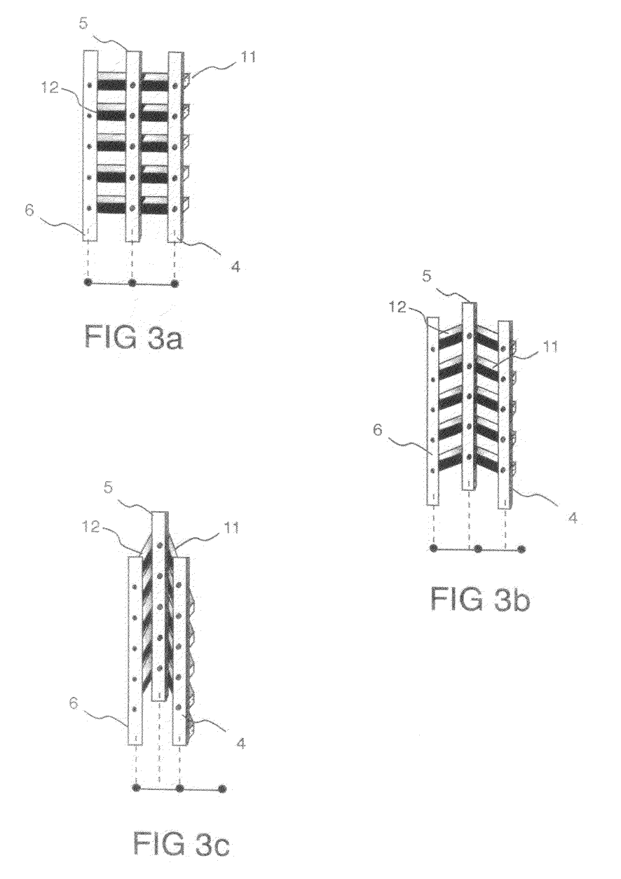

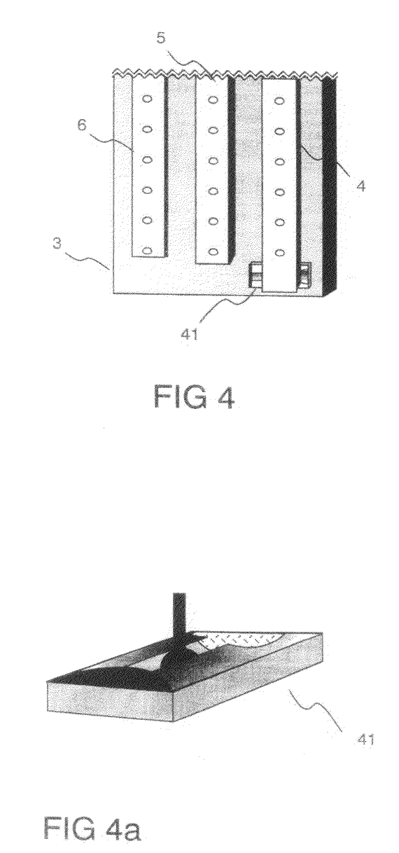

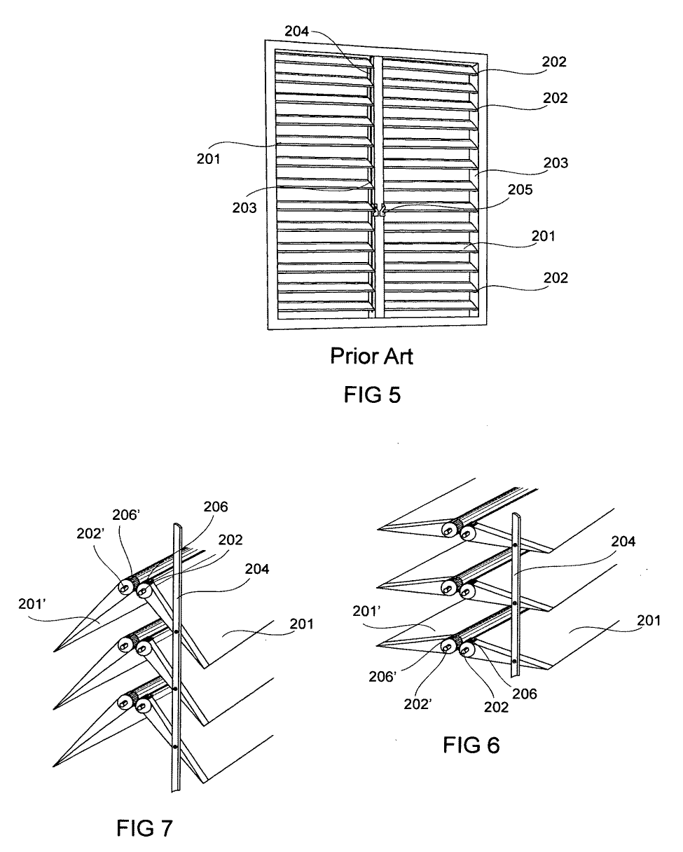

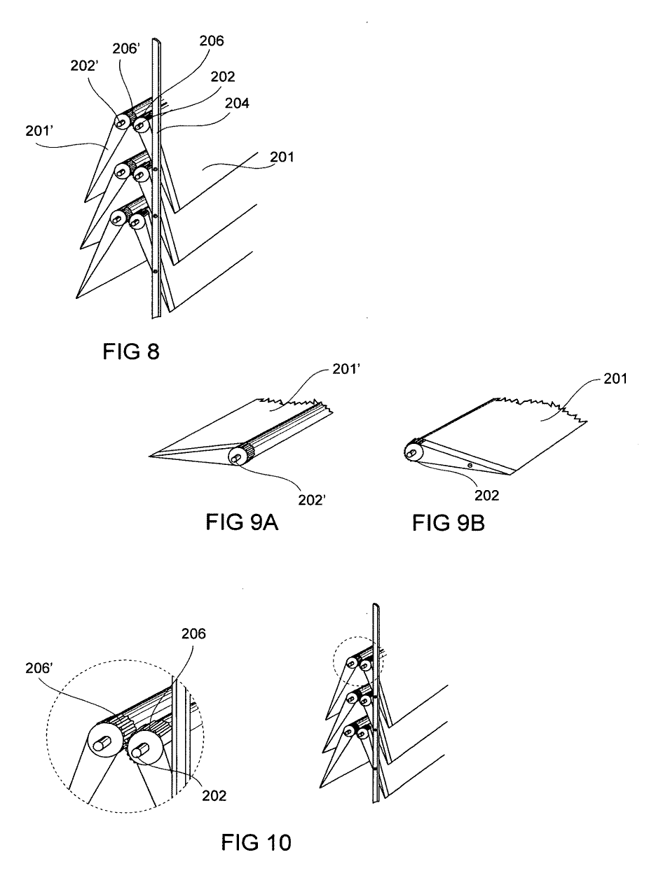

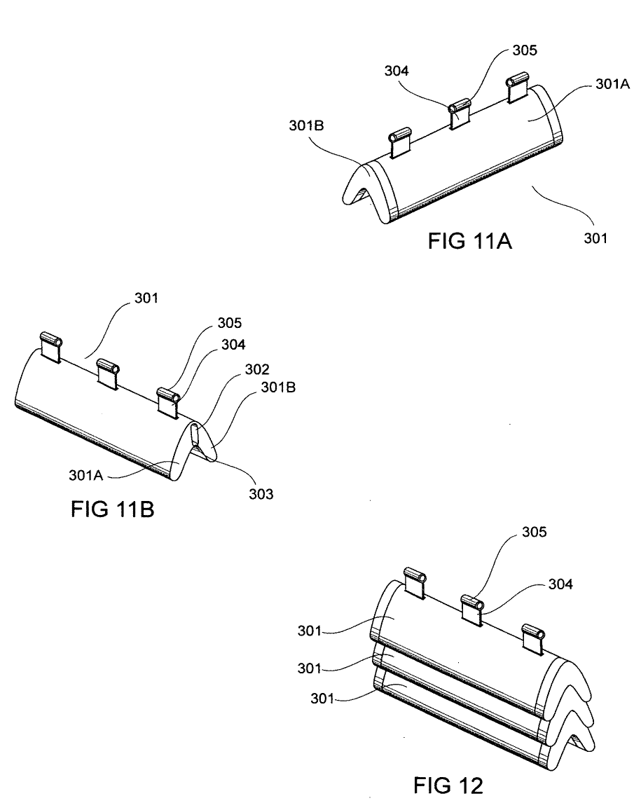

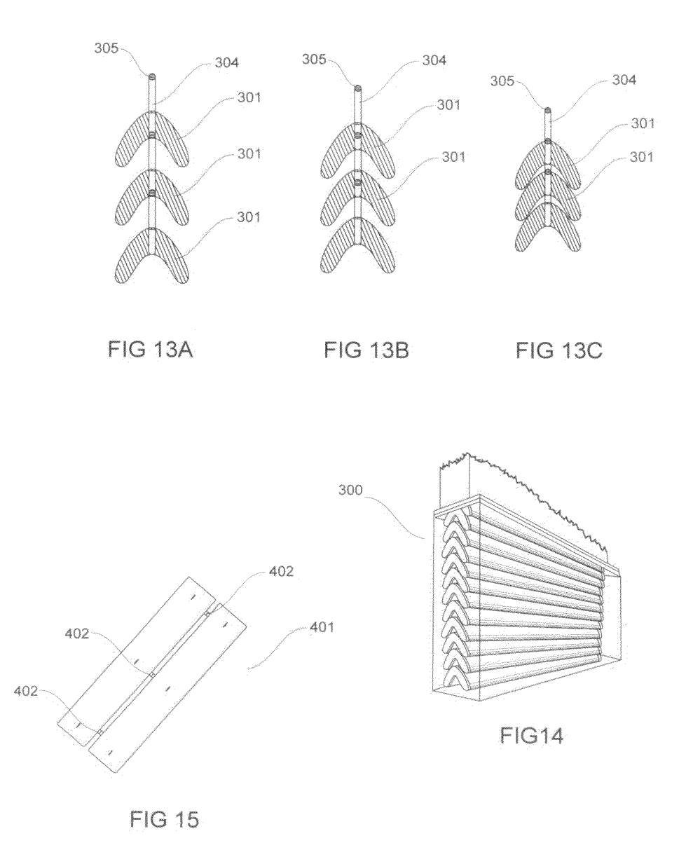

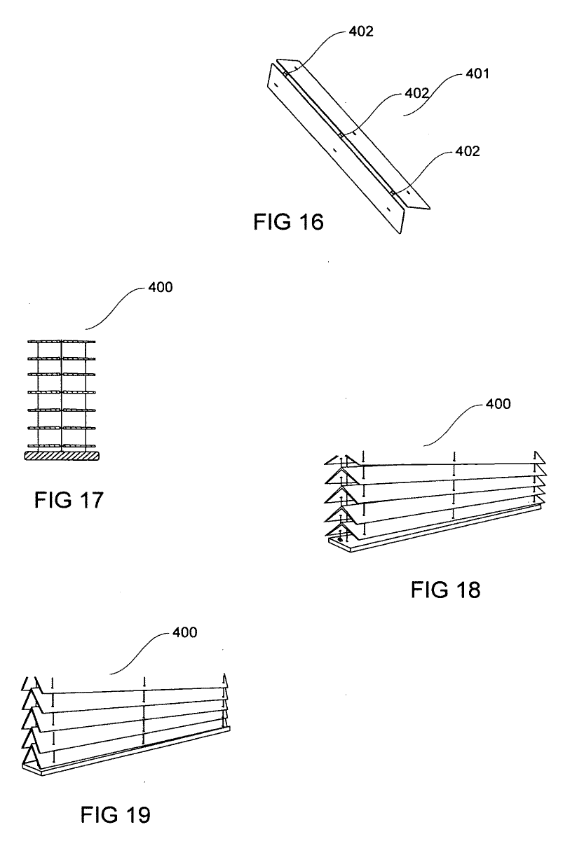

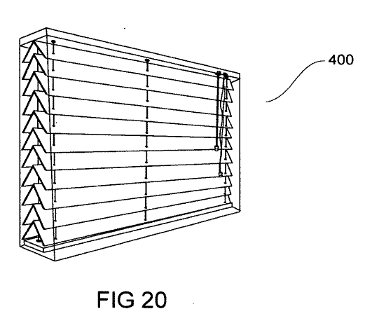

### RELATED APPLICATIONS

This application is a continuation of PCT Application No. PCT/IL2008/001597 filed on 19 Dec. 2008, which itself claims priority to Israeli Patent application no. 188255 filed on 19 Dec. 2007.

### TECHNICAL FIELD

Window shades that let air into the room, but block out light.

### BACKGROUND ART

Most structures, including residential homes, businesses, factories and so on have windows that are covered with shades. As is known, shades are designed primarily to block out light, sun, wind and rain. Shades used today, enable either complete closing of the window by the shade in a way that prevents entrance of both light and air, or full or partial opening of the shade, in a way that lets in both light and air into the room. Shades used today do not enable to open the shade in a way that lets in air while blocking out light.

The present invention is a shade that is built and designed in a way that enables partial or full opening or closing of the shade, so that the shade may be in one of several positions: (1) prevent entrance of both light and air; (b) enable entrance of both light and air; (c) and in the special case of the present shade, a mid-way position is possible in which air is let in, but light is blocked out.

### THE INVENTION

(Numbers in parentheses refer to numbers in drawing)

Essentially, the present invention refers to a shade with three main positions. First, a position that lets both air and light into the room. Second, a position that prevents both air and light from entering the room. A mid-way position that lets air into the room but blocks out light.

The present invention refers to a shade with several louvers (1) positioned one above the other, in such a way that when they are closed, they serve as a shade and a barrier that prevents entrance of both light and air into the room. Each of the louvers (1) consists, in fact, of two parallel halves (11 and 12) that are connected to one another by means of a cylindrical rod (2) that serves as an axis and a connector between the two halves (11 and 12) of the louver (1).

The louver can be in opened position, i.e. both halves are in horizontal position, so as to create one single flat louver, as depicted in Drawing 1A (hereinafter referred to as “open position”). When the louver (1) is in open position, both air and light can enter into the room. The louver can be in a fully closed position, i.e. both halves are slanted sharply downward, as depicted in Drawing No. 1C (hereinafter referred to as “closed position”). When the louver (1) is in closed position, neither air nor light can enter into the room. The louver can also be in a mid-way position, i.e. both halves are only partially slanted downward, as depicted in Drawing No. 1C (hereinafter referred to as “mid-way position”). When the louver (1) is in mid-way position, air is let into the room, but light is blocked out.

The sides of the two halves (11 and 12) of the louver (1) are connected to the cylindrical rod (1), as depicted in Drawing No. 1D. Connection of the components is made using a connector (21) that enables axial movement (rotation) of each half of the louver relative to the cylindrical rod, which, as mentioned, serves as an axis between the two halves of the louver. The connector (21) can be, for instance, a stylish ring-shaped device that is inserted over the cylindrical rod (2), which has a protruding pin that is inserted into the side of the louver. In such a case, the connection is made using several such connectors (21), as depicted in Drawing No. 1D.

The louvers (1) are attached to the window frame (3). The louvers (1) are attached to the window frame (3) by means of three vertical strips (5), as depicted in Drawing No. 2.

In addition, pins and screws (110) (22) (12) are used to connect the louvers (1) to the window frame (3). The pins and screws are attached to and protrude from the ends of each of the halves (11) (12) of the louver as well as from the cylindrical rod (2).

One of the vertical strips (6) is permanently fixed to the window frame (3) (hereinafter referred to as the “fixed strip”). The entire length of the fixed strip (6) has holes into which the pins (120), which protrude from each of the halves is of each of the louvers (1), are inserted. The intervals between the holes on the fixed strip correspond to the distance between the louvers, as depicted, for instance, in Drawings Nos. 3A, 3B and 3C.

The middle strip (5) is not attached to the window frame (3) and can only move vertically (up and down) (hereinafter referred to as the “middle strip”). The entire length of the middle strip (5) also has holes into which the screws (22) that protrude from cylindrical rods (22) on each of the louvers (1), are inserted. The intervals between the holes on the middle strip correspond with the intervals between the holes on the fixed strip.

The third strip (4) is also not attached to the window frame (3) and can only move horizontally (right and left) (hereinafter referred to as the “horizontal strip”). [It is noted that the horizontal strip is actually positioned vertically in the system but due to its strictly horizontal motion it is called the “horizontal strip”, as mentioned.] The entire length of the horizontal strip (4) also has holes into which the pins (110) that protrude from each of the halves of each of the louvers (1), are inserted. The intervals between the holes on the horizontal strip correspond with the intervals between the holes on the fixed and middle strips.

Drawing No. 2 depicts strips (4), (5) and (6). The upper end of the middle strip is attached to the arm that is connected to the shade's operating system (7).

When the handle of the operating system (7) is turned, the arm rises and, as a result, the middle strip is pulled upward, and vice versa. Drawing No. 2 depicts strips (4), (5) and (6) in open position (in other words, the corresponding holes lie on a single, level line, and therefore, in such a case, when the louvers are attached to the strips as described above, they are in open position). (The louvers are not depicted in this drawing.)

Drawing No. 3A depicts, for illustration purposes only, strips (4), (5) and (6) along with several attached louvers. Strips (4), (5) and (6), as well as the louvers (1), are in open position. Drawing No. 3B depicts the strips (4), (5) and (6) and the louvers (1) in mid-way position, i.e. air can enter the room, but light cannot. Drawing No. 3C depicts strips (4), (5) and (6) and louvers (1) in fully closed position, i.e. neither air nor light penetrate into the room. In closed position, the bottom part of each half of each louver lightly touches the upper part of each half of the louver beneath it.

In order to stabilize the system components in general, and the louver in particular, the horizontal strip (4) must be attached to the window frame (3) by means of a plate (41) with a niche, which is permanently attached to the window frame (3). The bottom part of the horizontal strip is equipped with a pin (depicted in Drawing No. 4A), the tip of which is inserted into the niche on the plate (41), enabling the horizontal strip (4) to move to the right and left but preventing it from moving up, down and out, thus stabilizing the system.

The louvers (1), cylindrical rod (2), and strips (4), (5) and (6) can be made of any rigid material such as metal, aluminum, plastic, wood and so on. The hardware (21), (22), (110) and (120) used to connect the various components can be pins, screws, nails or any other similar means. The operating system (7) can be manual or electrical or any other method.

The first embodiment of the present invention is described in the application as originally filed.

The second embodiment of the present invention refers to the implementation of the invention with respect to standard plantation shutters, a specific and random example of which is depicted, for instance, in Drawing No. 5.

Standard plantation shutters are familiar to any average professional in the field and therefore there is no need to elaborate on their description and specification. Nevertheless, we will mention that in principle, standard plantation shutters are composed of the following parts and are constructed in the following manner: (a) Louvers (201). The louvers (201) are usually made of plastic or wood, although nowadays shutters with aluminum louvers are also available. Each of the louvers (201) is attached to the sides (203) of the shutter (203) by means of pivotal pins (202). The louvers are attached both to the right-hand side and to the left-hand side of the shutter. The louvers (201) are also connected to one another by means of a vertical rod (204) which is, in turn, attached to a lever (handle) (205). To open the shutters, the lever (handle) (205), which is attached to the vertical rod (204), which in turn is attached to each of the louvers (201), is moved upward and outwards, rotating the pivotal pin (202) and causing the louvers (201) to go from a vertical (closed) position to a horizontal (open) position. In order to close the shutters, the above-described action is reversed. In other words, in order to open the shutters, the level is lifted and in order to close them, the lever is lowered. So far this is all existing knowledge.

The second embodiment of the present invention refers to the implementation of the invention with respect to standard plantation shutters (200), as depicted in Drawings Nos. 6-10.

The plantation shutters (200), subject of the invention, are composed of louver pairs (201) (201′) that are connected to each other in a back-to-back manner, as depicted in Drawings Nos. 6-8. One louver (201) is depicted, for instance, in Drawing No. 9A, and the second louver (201′) is depicted, for instance, in Drawing No. 9B. The profile of the louvers is, in general, a narrow rectangular strip, although for aesthetic reasons, the design depicted in the drawings is of a tapered louver, such that one side of the louver is thick and the other side is thin and pointy.

Each of the louvers is attached, at its thick side, to a pivotal pin (202) (202′). Each of the louvers is attached to both sides of the shutters (the right-hand side of the louver is attached to the right-hand side of the shutter and the left-hand side of the louver is attached to the left-hand side of the shutter). Each pair of louvers (201) (201′) is attached at the thick end of the louvers. Each pair of louvers is connected by means of a pivotal connection, such that when the thin side of the first louver (201) tilts downward (closing the shutter), the thin side of the second louver (201′) tilts downward as well. Each pair of louvers is connected, as mentioned, by means of a pivotal connection that includes two sprocket wheels (206) (206′), each attached, respectively, to a pivotal pin (202) (202′), as depicted for instance in Drawing No. 10. The column of louvers (201) is attached to a vertical rod (204), which is attached, in turn, to a lever handle (205) that is used to open and close the shutters (200).

Drawing No. 6 depicts the shutters (200) in open position. Drawing No. 7 depicts the shutters (200) in a position whereby light cannot penetrate through the shutters, but air can flow through them. Drawing No. 8 depicts the shutters (200) in close position, preventing penetration of both light and air.

The third embodiment of the present invention refers to the implementation of the invention with respect to rolling shutters (300).

Standard rolling shutters are familiar to any average professional in the field and therefore there is no need to elaborate on their description and specification. In general, standard rolling shutters are composed of long and narrow slats that are interconnected to form the shutters. Above the window on which the rolling shutters are installed is a box containing a longitudinal axis, a set of sprocket wheels and a strap (usually a thin and narrow strip of fabric). To open the shutter, the user pulls on the strap, which in turn rotates the sprocket wheels inside the box, causing the shutters to roll upward and around the axis located in the box. In order to close the shutters, the above action is reversed. So far this is all existing knowledge.

The third embodiment of the present invention refers to the implementation of the invention with respect to standard rolling shutters (300), as depicted in Drawings Nos. 11-14.

The rolling shutters (300) are composed of a large number of interconnected slats (301). Each of the shutter's slats (301) is shaped like a long board with a triangular side profile, as depicted, for instance, in Drawing No. 11A. In other words, each slat is made up of two longitudinal sides (301A) (301B), which constitute the triangle's sides, whereas the base side of the triangle is missing. The side profile of the slat (301) is depicted in Drawing No. 11B. A slot (302) runs the entire length of the bottom of the inner part of the slat (301). The slot (302) is open and resembles an indentation (in profile) in that it is open to below (303) for the entire length of the slat (301), as depicted for instance in Drawing No. 11B. In addition, there is one (or more) protrusion (304) protruding up from the top of the slat (301), which is shaped like a thin, vertical, protruding plate. The protrusion (304) ends in a thickening of the plate into a horizontal, cylindrical rod (305) (hereinafter referred to as the “cylindrical ending”). The protrusion (304) with the cylindrical ending (305) is depicted, for instance, in Drawings Nos. 11A, 11B and 12.

The slats (301) of the shutter (300) are interconnected as depicted, for instance, in Drawings Nos. 12 and 13. The slats (301) are attached to one another by inserting the protrusion (304) of one slat (301) into the inner slot (302) of the slat (301) above it. The lower slat remains hanging from the upper slat thanks to the fact that the cylindrical ending (305) cannot pass through the down-facing opening (303) of the inner slot (302). In addition, because the diameter of the cylindrical ending (305) is smaller than the height of the inner slot (302), the lower slat can move vertically with respect to the upper slat, as depicted, for instance, in Drawings Nos. 13A, 13B and 13C.

Drawing 13A depicts the shutter with only three slats (301) (for illustration purposes). The slats are in open position, i.e., the cylindrical ending (305) of each slat is at the bottom of the inner slot of the slat above it, so that the space between the slats (301) is at a maximum. Drawing 13C depicts the shutter with only three slats (301) (for illustration purposes). The slats are in closed position, i.e., the cylindrical ending (305) of each slat is at the top of the inner slot of the slat above it, so that the space between the slats (301) is at a minimum. Drawing 13B depicts an interim position between the two above described positions.

The rolling shutters (300), subject of the invention, are used as follows: When the user wishes to darken the room, the shutters (300) are rolled down to close the window. After the lowest slat reaches the window sill, the shutter is in loose position, as depicted, for instance, in Drawing 13 A. In this position both air and light can penetrate through the shutters into the room. When the user continues to roll the shutter downward (closing it), the slats (301) come into contact with one another to a degree that enables air to flow into the room, but does not enable penetration of light, as depicted for instance in Drawing No. 13B. When the user continues to roll the shutter downward (closing it even more), the slats (301) come into full contact with one another to a degree that neither air nor light can penetrate into the room, as depicted for instance in Drawing No. 13C. Drawing No. 14 depicts the shutter in installed position on a window.

The fourth embodiment of the present invention refers to the implementation of the invention with respect to Venetian blinds (400), as depicted in Drawings Nos. 15-20.

Standard Venetian blinds are familiar to any average professional in the field and therefore there is no need to elaborate on their description and specification. Several models of Venetian blinds exist and they all operate according to the same principles. As a rule, Venetian blinds (which are also called horizontal blinds) are composed of an upper track that contains mechanisms for slanting and raising the blinds' slats. Beneath the track, the slats are attached to one another and the space created between the slats (when they are in horizontal position, i.e. open position) equals the width of the slat minus 10%-20%. The slats are connected to one another mainly by cords. A weight is positioned at the bottom of the bottom slat and is designed to maintain the blinds in downward orientation.

The blinds' mechanism includes a pulling cord and a slanting rod. By pulling the pulling cord, the slats rise upward, come into contact with one another, and lie horizontally on one another, against the top of the window frame. The blinds are lowered by releasing the pulling cord from the stopper and releasing the cord upward, thus lowering the slats. The slanting rod is designed to rotate the slats around their central horizontal axis so that each slat rotates a quarter of a rotation into vertical position, in other words, the blinds are in closed position.

The fourth embodiment of the present invention refers, as mentioned, to Venetian blinds (400). The Venetian blinds (400) are constructed and designed like existing standard Venetian blinds, with the following modifications.

Each of the slats (401) of the blinds (400), depicted for instance in Drawing No. 15, is composed of two halves, each of which is shaped a standard slat of a currently known standard Venetian blind. The two halves of the slat (401) are attached to each other at two (or more) attachment points (402). Drawing No. 15 depicts the slat pair (401), including three attachment points (402). The two halves of the slat (401) are connected at the attachment points (402) by a narrow and flexible strip, so that the two halves of the slat (401) can be slanted relative to one another to form a kind of triangular structure (hereinafter referred to as the “triangular position”), as depicted, for instance, in Drawing No. 16.

When the slats (401) are in horizontal position (in other words, in a position whereby the two halves of the slat form a continuous surface, as depicted for instance in Drawing No. 15 (hereinafter referred to as “flat position”) they are in fact attached to each other in a way that resembles the regular slats of standard Venetian blinds. In this position, pulling the pulling cord of the blind (400) raises the slats (401) to fully open position whereas releasing the pulling cord lowers the slats to closed position.

The difference between a standard Venetian blind and the blinds (400) subject of the present invention is manifested also in the way the slanting rod is connected to the slats (401). The blind's cords and mechanisms are assembled so that when the slanting rod is turned in order to bring the slats to vertical position (completely closed), the two halves of each slat (401) move from flat position, to triangular position, and finally to completely closed position.

Drawing No. 17 depicts the blinds (400) in unrolled but open position (in other words, all of the slats (401) are in flat position). In this position, both air and light can penetrate through the blinds. Drawing No. 18 depicts the blinds (400) whereby all of the slats (401) are in triangular position, in other words, an interim position in which light cannot penetrate, but air can flow through the blinds. Drawing No. 19 depicts the blinds (400) in an almost closed position, in which neither light nor air can penetrate through the blinds.

### DESCRIPTION OF THE DRAWINGS

The drawings attached to the application are not intended to limit the scope of the invention and the possible ways of its application. The drawings are intended only to illustrate the invention and constitute only one of many possible ways of its application. In addition, the proportions in the drawings are not exact, so as to illustrate the main components of the system. Thus, for instance, the louvers are longer and thinner than they appear in the drawings.

Drawing No. 1A: Drawing No. 1A depicts the louver (1) in open position. The louver (1) is composed of two halves (11) and (12), whose sides are connected to a cylindrical rod (2) that serves as an axis for the two halves; a pin (120) protrudes from the ends of the left half (12); a screw or nail (110) protrudes is from the ends of the right half (11); a screw or nail (22) protrudes from the ends of the cylindrical rod (2).

Drawing No. 1B: Drawing No. 1B depicts the louver (1) in mid-way position.

Drawing No. 1C: Drawing No. 1C depicts a the louver (1) in closed position.

Drawing No. 1D: Drawing No. 1D depicts a disassembled louver (1). The louver (1) is composed of two halves (11) and (12) whose sides are connected to a cylindrical rod (2) that serves as an axis for the two halves; the entire length of the cylindrical rod (2) is connected to the long side of each of the halves of the louver by means of a ring, which surrounds the cylindrical rod, that has a protruding pin that is inserted into the sides of the louver halves.

Drawing No. 2: Drawing No. 2 depicts one vertical side of the window frame (3) and the three strips (4), (5) and (6); the operating system of the shade (7) to includes an arm that is connected to the operating system and is attached to the upper part of the middle strip (5).

Drawing No. 3A: Drawing No. 3A depicts the louvers (1) in open position.

Drawing No. 3B: Drawing No. 3B depicts the louvers (1) in mid-way position.

Drawing No. 3C: Drawing No. 3C depicts the louvers (1) in closed position.

Drawing No. 3: Drawing No. 3 depicts the bottom part of one vertical side of the window frame (3) and the bottom part of the three strips (4), (5) and (6); a plate (41) that is permanently attached to the window frame (3), to which the horizontal strip (4) is connected by means of a nail or screw (not shown), enables horizontal movement only.

Drawing No. 4: Drawing No. 4 depicts the plate (41), including the niche and nail or screw.

Drawing No. 5 depicts existing and known standard plantation shutters.

Drawings No. 6-8 depict the shutters (200) including louvers (201) (201′), pins (202) (202′), sprocket wheels (206) (206′) and a vertical rod (204).

Drawing No. 9A depicts a louver (202).

Drawing No. 9B depicts a louver (202′).

Drawing No. 10 depicts the sprocket wheels (206) (206′).

Drawings Nos. 11A and 11B depict a slat (301) and its components.

Drawing No. 12 depicts several slats (301).

Drawings Nos. 13A, 13B and 13C depict several slats (301).

Drawing No. 14 depicts the shutters (300).

Drawings Nos. 15-16 depict the slat (401).

Drawings Nos. 17-19 depict the interconnected slats (401).

Drawing No. 20 depicts the blinds (400).

What is claimed is:

1. A window shade that is composed of louvers, each of which consists of two parts positioned at varying angles to each other, such that the angle between the two parts of the louver can be changed and the shade can be fully closed, fully opened or in a position that lets air, but not light, into the room.

2. The shutter mentioned in claim No. 1 whereby the shutter is a plantation shutter constructed as follows: (a) Pairs of louvers that are attached to one another in a back-to-back manner by a pivotal connection, so that when the external edge of one said louver is slanted downward (closing the shutter), the external edge of the other said louver is also slanted downward; (b) each of the said louvers is attached to the sides of the said shutter using a pivotal pin; (c) the inner edges of each of the said louver pairs are attached to one another using a pivotal attachment, such as a pivotal attachment that includes two sprocket wheels that are attached, respectively, to the two said pivotal pins.

3. The shutter mentioned in claim No. 1 whereby the shutter is a rolling shutter constructed as follows: (a) The said rolling shutter is made up of several interconnected slats; (b) each of the said slats is shaped like a long board with a triangular side profile; (c) the bottom of the inner part of each of the said slats has a slot that runs the entire length of the said slat; the said slot is designed like an indentation with an opening running the entire length of the said slat; (d) at the top of each said slat is one (or more) protrusion, shaped like a thin plate that protrudes vertically out of the top of the said slat; the top of the said protrusion ends in an ending that is relatively wide in relation to the said protrusion and is shaped like a cylindrical rod (referred to as a “cylindrical ending”); (e) the said slats of the said shutter are attached to one another by inserting the said protrusion of the said slat into the said inner slot of the said slat positioned above it;

4. The said shutter mentioned in claim No. 1 whereby it is a Venetian blind constructed so that each of the slats of the said blind is halved lengthwise and is composed of two halves, such that each of them is like one slat of a Venetian blind; the two said halves of the said slat are attached to one another at two or more attachment points using a narrow and flexible strip, such that the two said halves can be in a flat and horizontal position relative to each other or slanted relative to each other so as to form a kind of triangular structure or be completely closed; the slats are attached to a pulling cord that enables the slats to be lowered or raised in flat, horizontal position and they are also attached to a slanting rod, which when turned causes the edges of the two said halves to slant downwards such that when the slanting rod is turned, the two halves change their position, from a flat, horizontal position to a triangular position to a completely closed position.
